(19) United States
(12) Patent Application Publication
(10) Pub. No.: US 2014/0054914 A1
(43) Pub. Date: Feb. 27, 2014

(54) METHOD FOR PRODUCING AN INTERCHANGEABLE VEHICLE INTERIOR LINING

(71) Applicants: Hwa Cheng Teoh, Kuala Lumpur (MY); Chee Keng Sam, Kuala Lumpur (MY); Chen Xiang Wong, Kuala Lumpur (MY)

(72) Inventors: Hwa Cheng Teoh, Kuala Lumpur (MY); Chee Keng Sam, Kuala Lumpur (MY); Chen Xiang Wong, Kuala Lumpur (MY)

(73) Assignee: PECCA LEATHER SDN BHD, Kuala Lumpur (MY)

(21) Appl. No.: 14/006,762

(22) PCT Filed: Aug. 15, 2011
(86) PCT No.: PCT/MY2011/000189

§ 371 Date: Nov. 6, 2013

(30) Foreign Application Priority Data
Mar. 23, 2011 (MY) PI2011001296

(51) Int. Cl. B60R 13/02

(52) U.S. Cl. CPC B60R 13/0206
USPC 296/1.08; 156/281

(57) ABSTRACT

An interchangeable vehicle interior lining (100) comprising a moulded base (102) with an inner and an outer surface, prepared for an vehicle interior part (105) onto which the lining (100) is to be assembled; an adhesive (103) applied onto the outer surface of the moulded base (102); a desired decorative material (101) adhered onto the adhesive outer surface of the moulded base (102); and a plurality of fixing means (107) mounted along the periphery of the lining (100) for closely fitting the lining (100) onto the vehicle interior part (105).

### FIELD OF INVENTION

The present invention relates to an interchangeable vehicle interior lining. In more particular, the present invention provides a method for producing an interchangeable vehicle interior lining, such as a vehicle door trim panel or a dash board lining, and the interchangeable vehicle interior lining produced thereof.

### BACKGROUND OF THE INVENTION

Vehicle interior linings are usually assembled onto the vehicle's interior, for example, the linings for door trim panels, dash boards, motorbike tanks or others. The vehicle interior linings are great idea to prevent various vehicle interior compartments from being destroyed by deleterious factors, such as spilt dirts, wetness, friction or harsh sunlight. They are also meant for the purpose of protecting the original fabric of the vehicle's interior, prolonging its durability, as well as beautifying thereof.

Conventionally, the manufacture of vehicle interior linings are deemed difficult and encountered various problems as the entire compartment, for which a lining is to be fabricated therefrom and assembled thereonto, is to be removed from the vehicle. This particular compartment can only be re-configured back into the vehicle after the assembly of the fabricated vehicle interior linings. In short, the assembling process of the vehicle interior linings in both original equipment manufacture (OEM) and aftermarket is time-consuming and requires the employment of highly skilled workers.

In the prior arts, there are some patented technologies disclosed relating to the production of thermoplastic article for vehicle interior linings. U.S. Pat. No. 5,641,379 relates to an apparatus for producing a thermoplastic article having an undercut cross-section. The apparatus comprises a moulding element having a working surface against which a previously-heated sheet of thermoplastic material is urged. This equipment is suitable for fabricating a motor-vehicle door lining panel. The invention focuses on the use of the apparatus with an application of a jet of compressed air for moulding the thermoplastic article. The process for producing this thermoplastic article relying on this apparatus is complicated, which may also be time-consuming and not cost-effective.

Another U.S. Pat. No. 6,092,858 also discloses a moulded interior door panel for a vehicle, which includes a thermoformable sheet and an insert wherein a portion of the thermoformable sheet at least partially envelopes and retentively grips the insert. This invention discloses a method for producing the moulded article, such as the door pull, by providing a moulding process including at least one moulding die which involves multiple steps. Besides, there is no method for attaching the mould being disclosed. The moulded article thereof is merely meant for avoiding evident junction lines between the door panel and handle.

There is also another U.S. Pat. No. 7,000,970 relating to a moulded dashboard cover. Accordingly, the dashboard cover is formed from plastic, fiberglass, polypropylene or related synthetic materials to give the dashboard of a vehicle a smooth appearance or an ornate appearance. The moulded dashboard cover is retained in place on the vehicle dashboard by a front lip which is press fit between the front upper surface of the dashboard and the interior surface of the windshield and an interior rear lip which is press fit between the rear of the dashboard and the face cover of the instrument panel. This invention mainly aims to provide a smooth or ornate covering to the dashboard, there is no method for fabricating a mould of dashboard, or any detachability of dashboard addressed.

Other moulded articles for vehicle interior linings are also disclosed in the prior arts. Malaysia Patent No. 20082257 discloses a method for making a moulded article having multiple layers, such as coverstock, decorative element and a moulded substrate. PCT publication No. WO2008086081 relates to a method for providing a preform laminate having a compressible material sandwiched between a flexible skin and a back skin. U.S. Pat. No. 6,210,613 discloses a method for making a door trim panel assembly by placing a door trim substrate into a cavity of a mould which also includes the step of pre-joining more than one component to the door trim substrate. Most of these technologies disclose a door trim panel having various layers. However, none of these patented technologies involves a process for providing a simple moulding means for the fabrication of the vehicle interior linings which eases the process of assembling the moulded articles onto the vehicle. The patented technologies also do not disclose any interchangeability of the articles.

Interchangeability of a vehicle interior lining is vital to improve the appearance of the vehicle's interior and enhance the value of the vehicle by providing a luxurious look. Besides, it promotes the hygiene in the internal environmental of the vehicle. It also allows various designs of the vehicle interior linings for accommodating different lifestyles and preferences of a user. As there is thus far no patented technology relating to the production of interchangeable vehicle interior lining, particularly vehicle interior lining which can be closely-fitted onto the vehicle's interior, it is therefore desirable for the present invention to provide a method for producing an interchangeable vehicle interior lining and a lining thereof which is capable of overcoming most of the drawbacks of the prior arts.

### SUMMARY OF INVENTION

The primary object of the present invention is to provide a vehicle interior lining which is interchangeable thus allowing various designs of the vehicle interior lining to be assembled onto a vehicle's interior.

Another object of the present invention is to provide a simple method for producing a vehicle interior lining which allows the easy, convenient and time-saving assembly of the vehicle interior lining onto a vehicle's interior.

Still another object of the present invention is to provide a method for producing a vehicle interior lining which involves the fabrication of a mould that can act as supporting means and eases the process for manufacturing the linings therefrom.

Still another object of the present invention is to innovate a method for producing a vehicle interior lining which can be closely fitted onto the vehicle's interior without destroying the texture of the original fabric of the vehicle's interior.

Yet another object of the present invention is to produce an interchangeable vehicle interior lining as the additional lining of the vehicle's interior which is capable of protecting its original fabric, prolonging its durability as well as enhancing the value of the vehicle by providing it a more luxurious look.

Yet another object of the present invention is to provide an interchangeable vehicle interior lining having various designs which give the best aesthetic appearance to the vehicle's interior as well as high level of comfortability to the user of the vehicle.

Further object of the present invention is to produce an interchangeable vehicle interior lining which can be made of various materials, having various designs, as well as comparable in quality yet low in production cost.

At least one of the preceding objects is met, in whole or in part, by the present invention, in which one of the embodiments of the present invention describes an interchangeable vehicle interior lining (100) comprising a moulded base (102) with an inner and an outer surface, prepared for an vehicle interior part (105) onto which the lining (100) is to be assembled; an adhesive (103) applied onto the outer surface of the moulded base (102); a desired decorative material (101) adhered onto the adhesive outer surface of the moulded base (102); and a plurality of fixing means (107) mounted along the periphery of the lining (100) for closely fitting the lining (100) onto the vehicle interior part (105).

According to one of the preferred embodiments of the present invention, the interchangeable vehicle interior lining (100) can be customized for various parts of the vehicle's interior. These parts include a door trim panel, a dashboard, a motorbike storage box, a glovebox, a gear shift, a parking brake handle, a steering, a console box, an armrest, a door handle, rear speaker covers and side pillars.

Another preferred embodiment of the present invention discloses that the moulded base (102) is made of polyethylene terephthalate (PET), acrylonitrile butadiene styrene (ABS), polypropylene (PP) and polycarbonate (PC).

Still another preferred embodiment of the present invention discloses that the adhesive (103) applied is glue or double-sided adhesive tape.

In yet another preferred embodiment of the present invention, it is disclosed that the decorative material (101) is made of leather, polyvinylchloride (PVC), polyurethane (PLT), fabric or microfibre.

In still another preferred embodiment of the present invention, it is disclosed that the fixing means (107) is a clip or a hook.

Preferably, the vehicle interior lining (100) according to the preceding embodiments is formed into a thickness ranging from 0.5 mm to 1.2 mm. Most preferably, the thickness is in a range of 0.8 mm to 1.0. mm.

According to a further embodiment of he present invention, the lining (100) further comprises a detachable fastening means (104) mounted on the inner surface of the moulded base (102) Preferably, the detachable fastening means (104) is a double-sided adhesive or a hook-and-loop.

Another further embodiment of the present invention is a method for producing an interchangeable vehicle interior lining (100) comprising the steps of preparing a moulded base (102) with an inner and an outer surface, for a vehicle interior part (105) onto which the lining (100) is to be assembled; applying an adhesive (103) onto the outer surface of the moulded base (102); adhering a desired decorative material (101) onto the adhesive outer surface of the moulded base (102); and mounting a plurality of fixing means (107) along the periphery of the lining (100) formed.

According to another preferred embodiment of the present invention, the adhesive (103) is applied onto the outer surface of the moulded base (102) by spraying; whereas the desired decorative material (101) is preferably adhered onto the moulded base (102) by press forming or vacuum forming.

As set forth in the preceding embodiment, the method can further comprises a step of adding a detachable fastening means (104) on the inner surface of the moulded base (102). The detachable fastening means (104) is preferably a double-sided adhesive or a hook-and-loop.

According to another preferred embodiment of the present invention, the interchangeable vehicle interior lining (100) can be closely fitted onto the vehicle interior part (105) via a detachable fastening means (104). Preferably, the detachable fastening means (104) is a double-sided adhesive tape or a hook-and-loop.

One skilled in the art will readily appreciate that the present invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a front view of a door trim panel lining, an example for the vehicle interior lining (100) with its fixing means (107) as described by one of the preferred embodiments of the present invention.

FIG. 2 is a partial exploded view of the vehicle interior lining (100) of FIG. 1, showing the adhesive (103) in between the decorative material (101) and the moulded base (102).

FIG. 3 is a back view of the vehicle interior lining (100) of FIG. 1, showing the location of the detachable fastening means (104) on the back of the moulded base (102).

FIG. 4 is a front view of a door trim panel with original fabric (106) as described by one of the preferred embodiments of the present invention.

FIG. 5 is a perspective view of the assembly of the vehicle interior lining (100) of FIG. 1 onto the vehicle's interior.

FIG. 6 is a front view of a door trim panel assembled with the vehicle interior lining (100) of FIG. 1.

FIG. 7 is a front view of a door trim panel lining, another example of the vehicle interior lining (100) having a different design from that of FIG. 1, as described by another preferred embodiment of the present invention.

FIG. 8 is a back view of the vehicle interior lining (100) of FIG. 7 showing the location of the detachable fastening means (104) and the fixing means (107).

### DETAILED DESCRIPTION OF THE INVENTION

The present invention relates to a method for producing an interchangeable vehicle interior lining. In more particular, the present invention provides a method for producing an interchangeable vehicle interior lining, such as a vehicle door trim panel or a dash board lining, and the interchangeable vehicle interior linings produced thereof.

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The present invention discloses an interchangeable vehicle interior lining (100) comprising a moulded base (102) with an inner and an outer surface, prepared for an vehicle interior part (105) onto which the lining (100) is to be assembled; an adhesive (103) applied onto the outer surface of the moulded base (102); a desired decorative material (101) adhered onto the adhesive outer surface of the moulded base (102); and a plurality of fixing means (107) mounted along the periphery of the lining (100) for closely fitting the lining (100) onto the vehicle interior part (105).

According to one of the preferred embodiments of the present invention, the interchangeable vehicle interior lining (100) can be customized for various parts of the vehicle's interior. These parts include a door trim panel, a dashboard, a motorbike storage box, a glovebox, a gear shift, a parking brake handle, a steering, a console box, an armrest, a door handle, rear speaker covers and side pillars. Illustrated in FIG. 1 is one of the examples of the interchangeable vehicle interior lining (100) as described in the preferred embodiment of the present invention, which is a lining (100) for the vehicle door trim panel with a plurality of fixing means (107) mounted thereon.

In another embodiment of the present invention, a method for producing an interchangeable vehicle interior lining (100) is disclosed. This method comprises the steps of preparing a moulded base (102) with an inner and an outer surface, for a vehicle interior part (105) onto which the lining (100) is to be assembled; applying an adhesive (103) onto the outer surface of the moulded base (102); adhering a desired decorative material (101) onto the adhesive outer surface of the moulded base (102); and mounting a plurality of fixing means (107) along the periphery of the lining (100) formed.

FIG. 2 shows a partial exploded view of the moulded lining (100) of FIG. 1, showing the layer of adhesive (103) applied in between the decorative material (101) and the moulded base (102). According to the preferred embodiment of the present invention, the interchangeable vehicle interior lining (100) is composed of a moulded base (102) which is formed into the shape of a particular vehicle interior part (105) onto which the lining (100) is to be assembled.

The moulded base (102) is made of a thermoplastic material such as PET, ABS, PP or PC. Accordingly, the moulded base (102) can be obtained from the particular vehicle interior part (105) by moulding thereon the thermoplastic material. As a result, a large amount of similar moulded bases can be mass-produced therefrom. The moulded base (102) plays an important role in the process of producing the interchangeable vehicle interior lining (100) as it can act both as a supporting means as well as a moulding means which will provide a lining that can be closely fitted onto the particular vehicle part (105).

Subsequently, the moulded base (102) is subjected to the adhesive application process. In accordance with the preferred embodiment of the present invention, the adhesive (103) is applied onto the moulded base (102) by a spraying process. As shown in FIG. 2, the adhesive (103) is sprayed onto an outer surface of the moulded base (102). Preferably, the adhesive (103) is glue or double-sided adhesive tape.

After the application of the adhesive, a decorative material (101) is to be adhered onto the adhesive moulded base (102). Preferably, the decorative material (101) is made of leather, PVC, PU, fabric or microfibre. Leather material is the most preferred decorative material (101) to be applied as this material can give the best aesthetic appearance demanded by most of the vehicle users. Apart from its decorative purpose, the decorative material (101) also functions as a protection layer which is capable of protecting the original fabric (106) and prolong the durability of the vehicle interior part (105). The desired decorative material (101) is preferably adhered onto the moulded base (102) by a press forming or vacuum forming process. Heat is applied during this adhering process.

The selection of material as well as the thickness of the interchangeable vehicle interior lining (100) is vital in order to allow its easy, convenient and time-saving assembly onto a vehicle's interior. Preferably, the interchangeable vehicle interior lining (100) is formed into a thickness ranging from 0.5 mm to 1.2 mm. Most preferably, the thickness of the lining (100) is in a range of 0.8 mm to 1.0 mm.

As shown in FIGS. 1 to 3, the vehicle interior lining (100) is mounted with a plurality of fixing means (107) along its periphery. In accordance with the preferred embodiment of the present invention, the fixing means (107) is a clip, a hook or any other suitable fixing materials, which is capable of engaging the vehicle interior lining (100) closely and firmly onto the vehicle's interior. These fixing means (107) can also be of various suitable sizes and shapes, provided that they are able to hold and fix the lining (100) onto the vehicle interior part (105) to obtain a close-fit.

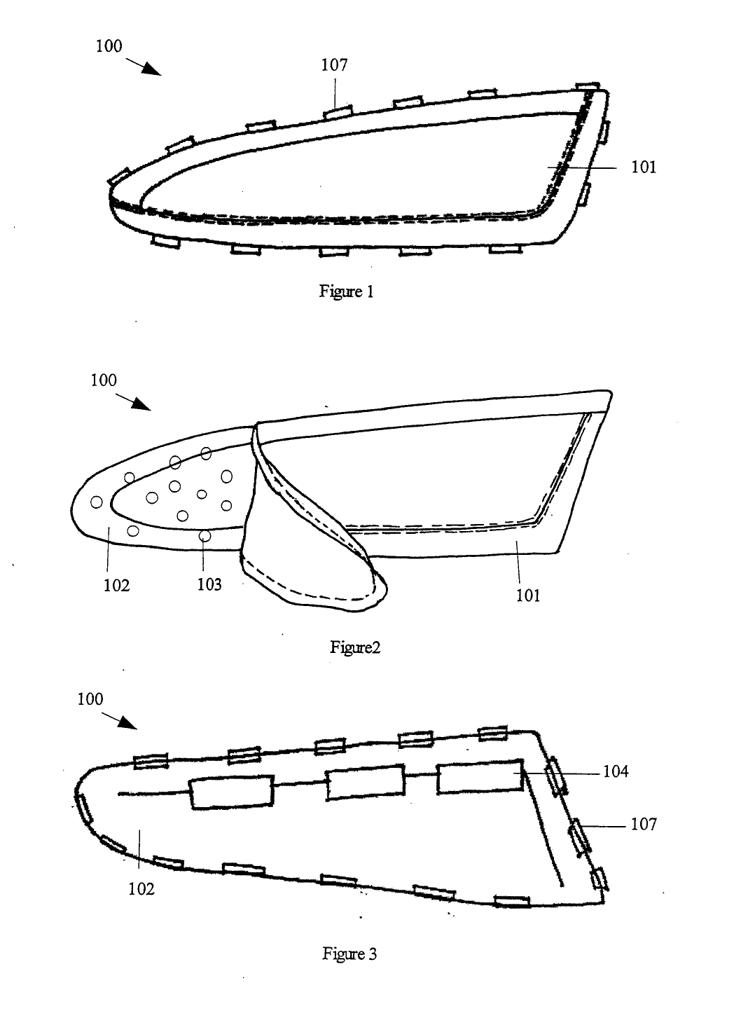

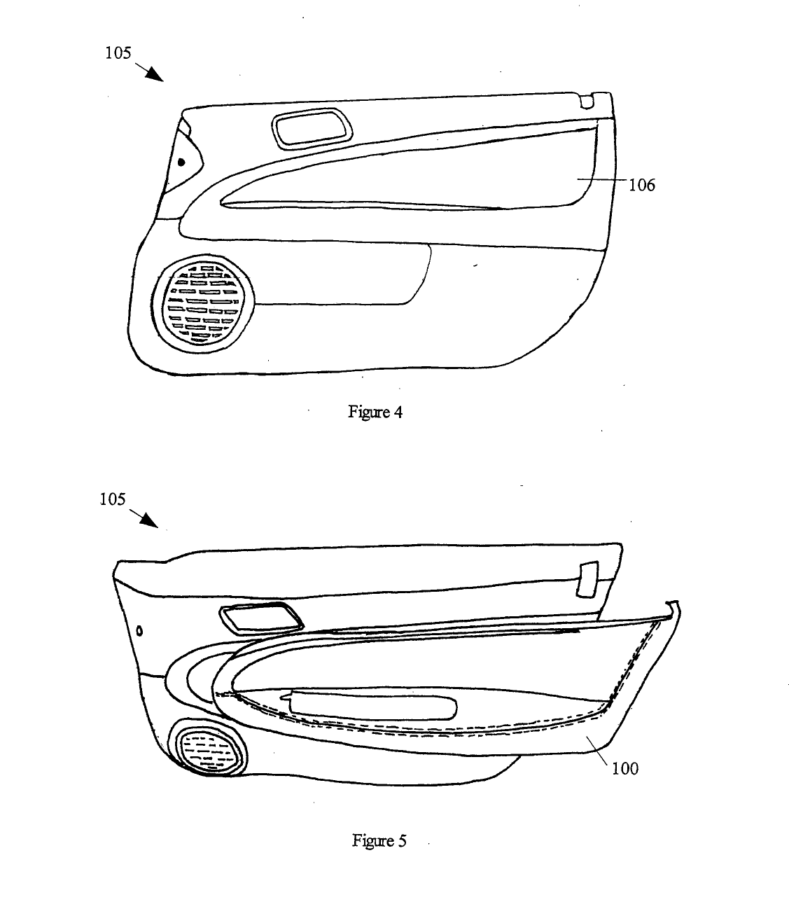

Illustrated in FIG. 3 is a vehicle interior lining (100) which is incorporated with one or more detachable fastening means (104). These detachable fastening means (104) can be mounted on the inner surface of the moulded base (102) to enhance the close-fitting between the vehicle interior lining (100) and the vehicle interior part (105). Preferably, the detachable fastening means (104) is a double-sided adhesive tape as illustrated in FIG. 3, or a hook-and-loop which can be commercially obtained under the tradename of Velcro.

The vehicle interior lining (100) provided by the present invention allows the interchangeability of the vehicle interior linings (100) of various designs to be assembled onto a vehicle's interior. These various designs give the best aesthetic appearance to the vehicle's interior as well as high level of comfortability to the user of the vehicle. The lining (100) can be assembled onto the vehicle interior part (105) which is having or without an original fabric.

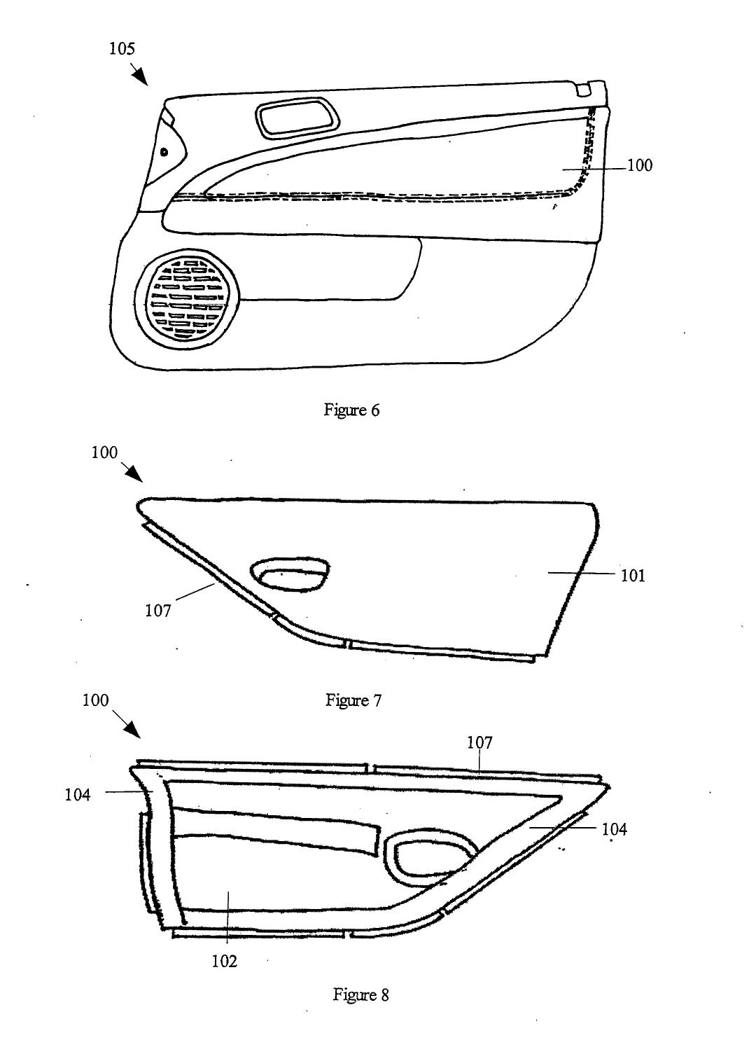

FIG. 4 shows a front view of a door trim panel with original fabric (106) as described by one of the preferred embodiments of the present invention, whereas the assembly of the moulded vehicle interior lining (100) onto the vehicle's interior is demonstrated in FIG. 5. Accordingly, the vehicle interior lining (100) produced according to the method of the present invention can be closely-fitted onto the vehicle interior part (105) by the facility of fixing means (107) along the periphery of the lining (100). As illustrated in FIG. 5, the plurality of clips can be inserted into the slit or gap present at the rim of the particular vehicle interior part (105), and closely engaged to the vehicle interior part (105). According to another preferred embodiment of the present invention, the interchangeable vehicle interior lining (100) can be closely fitted onto the vehicle interior part (105) without destroying the texture of the original fabric of the vehicle's interior, as shown in FIG. 6.

FIGS. 7 and 8, respectively show a front and back view of a door trim panel lining, which is another example of the vehicle interior lining (100) having a different design from that of FIG. 1, as described by another preferred embodiment of the present invention. As shown in FIG. 7, the fixing means (107) can be of elongated shape, with or without a hooking means. FIG. 8 shows the location of the detachable fastening means (104) on the moulded base (102). Both the fixing means (107) and the detachable fastening means (104) acts as an integrated close-fitting system which is capable of closely fitting the vehicle interior lining (100) onto the vehicle interior part (105).

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1. An interchangeable vehicle interior lining, comprising:
a moulded base with an inner and an outer surface, prepared for a vehicle interior part onto which the lining is to be assembled;
an adhesive applied onto the outer surface of the moulded base;
a desired decorative material adhered onto the adhesive outer surface of the moulded base; and
a plurality of fixing members mounted along the periphery of the lining for closely fitting the lining onto the vehicle interior part.

2. The lining according to claim 1, wherein the moulded base is made of a material selected from the group consisting of polyethylene terephthalate (PET), acrylonitrile butadiene styrene (ABS), polypropylene (PP), polycarbonate (PC) and combinations thereof.

3. The lining according to claim 1, wherein the vehicle interior part is a door trim panel, a dashboard, a motorbike storage box, a glovebox, a gear shift, a parking brake handle, a steering, a console box, an armrest, a door handle, rear speaker covers or side pillars.

4. The lining according to claim 1, wherein the adhesive is glue or double-sided adhesive tape.

5. The lining according to claim 1, wherein the decorative material is made of a material selected from the group consisting of leather, polyvinylchloride (PVC), polyurethane (PU), fabric, microfiber and combinations thereof.

6. The lining according to claim 1, wherein the fixing members are a clip or a hook.

7. The lining according to claim 1, wherein the lining has a thickness ranging from 0.5 mm to 1.2 mm.

8. The lining according to claim 1, further comprising a detachable fastening member mounted on the inner surface of the moulded base.

9. The lining according to claim 8, wherein the detachable fastening member is a double-sided adhesive or a hook-and-loop system.

10. A method for producing an interchangeable vehicle interior lining, comprising:
preparing a moulded base with an inner and an outer surface, for a vehicle interior part onto which the lining is to be assembled;
applying an adhesive onto the outer surface of the moulded base;
adhering a desired decorative material onto the adhesive outer surface of the moulded base; and
mounting a plurality of fixing members along the periphery of the formed lining.

11. The method according to claim 10, wherein the moulded base is made of a material selected from the group consisting of polyethylene terephthalate (PET), acrylonitrile butadiene styrene (ABS), polypropylene (PP), polycarbonate (PC) and combinations thereof.

12. The method according to claim 10, wherein the vehicle interior part is a door trim panel, a dashboard, a motorbike storage box, a glovebox, a gear shift, a parking brake handle, a steering, a console box, an armrest, a door handle, rear speaker covers or side pillars.

13. The method according to claim 10, wherein the adhesive is applied onto the outer surface of the moulded base by spraying.

14. The method according to claim 10, wherein the adhesive is glue or double-sided adhesive tape.

15. The method according to claim 10, wherein the decorative material is made of a material selected from the group consisting of leather, polyvinylchloride (PVC), polyurethane (PU), fabric, microfibre and combinations thereof.

16. The method according to claim 10, wherein the desired decorative material is adhered onto the moulded base by press forming or vacuum forming

17. The method according to claim 10, wherein the fixing members are a clip or a hook.

18. The method according to claim 10, wherein the interchangeable vehicle interior lining is formed into a thickness ranging from 0.5 mm to 1.2 mm.

19. The method according to claim 10, further comprising the step of adding a detachable fastening member on the inner surface of the moulded base.

20. The method according to claim 19, wherein the detachable fastening member is a double-sided adhesive or a hook-and-loop system.
